(19) United States
(12) Patent Application Publication
(10) Pub. No.: US 2013/0185112 A1
(43) Pub. Date: Jul. 18, 2013

(54) OPTIMIZING BENEFITS OF COMMUNITY DEVELOPMENT WITH REFERENCE TO RESOURCES THROUGH MULTIPLE TIME PERIODS FOR MULTIPLE COOPERATING AND COMPETING ENTITIES WITH REFERENCE TO MULTIPLE DIMENSIONS

(71) Applicants: Robert R. Friedlander, Southbury, CT (US); James R. Kraemer, Santa Fe, NM (US)

(72) Inventors: Robert R. Friedlander, Southbury, CT (US); James R. Kraemer, Santa Fe, NM (US)

(73) Assignee: INTERNATIONAL BUSINESS MACHINES CORPORATION, Armonk, NY (US)

(21) Appl. No.: 13/350,023

(22) Filed: Jan. 13, 2012

(51) Int. Cl. G06Q 10/06

(52) U.S. Cl. 705/7.22; 705/7.23

(57) ABSTRACT

A method, system and computer program product for optimizing resources for organizations. The steps include discovering goals and objectives of organizations and resources available from resource groups and storing the data in a repository; categorizing the data regarding the goals and objectives and the resources available; matching the resources available from the resource groups with the goals and objectives of the organizations; assigning values and weights to the resources and optimizing the resources; determining global optima and parse the global optima into resource allocation subsets, sending the subsets to the resource groups; capturing locally chosen resource allocation from the resource groups and storing the locally chosen resource allocation in the repository; determining unstated weights and values from the locally chosen resource allocation from the resource groups; storing actual pairings of the resources with a project of the organization, and recalculating the global optima based on remaining resources available.

### BACKGROUND

The present invention relates to optimizing the benefits of community development with references to resources, and more specifically to optimizing the benefits of community development with references to resources through multiple time periods for multiple cooperating and competing entities with reference to multiple dimensions.

Large scale community development can be very complex and involves obtaining and finding heterogeneous resources to fulfill the needs of specific planned projects. Depending on the community organization, the knowledge of what resources are available is limited and can become stagnant over time as well the resources becoming depleted. It is also difficult for the community organizations to find resource organizations that may not be within the same region as the organization that have the availability of resources and share the same goals, objectives and political views as the community organization.

With some clarification and by being able to match resources from various levels with community projects on various levels that maintain the goals, objectives and political views of the organizations involved, the benefits to the community can be maximized through time.

### SUMMARY

According to one embodiment of the present invention, a method for optimizing resources for organizations. The method comprising the steps of: a computer discovering goals and objectives of organizations and the resources available from resource groups and storing data regarding the goals and objectives and the resources in a repository; the computer categorizing the data regarding the goals and objectives and the resources available and storing the categorized data in the repository; the computer matching the resources available from the resource groups with the goals and objectives of the organizations and storing the matches in the repository; the computer assigning values and weights to the resources and optimizing the resources; the computer determining global optima and parsing the global optima into resource allocation subsets for each resource group and sending the resource allocation subsets to the resource groups; the computer capturing locally chosen resource allocation from the resource groups and storing the locally chosen resource allocation in the repository; the computer determining unstated weights and values from the locally chosen resource allocation from the resource groups; the computer storing actual pairings of the resources with a project of the organization; and the computer recalculating the global optima based on remaining resources available from the resource groups and storing the recalculated global optima in the repository.

According to another embodiment of present invention, a computer program product for optimizing resources for organizations. The computer program product comprising: one or more computer-readable, tangible storage devices; program instructions, stored on at least one of the one or more storage devices to, discover goals and objectives of organizations and the resources available from resource groups and storing data regarding the goals and objectives and the resources in a repository; program instructions, stored on at least one of the one or more storage devices to, categorize the data regarding the goals and objectives and the resources available and storing the categorized data in the repository; program instructions, stored on at least one of the one or more storage devices to, match the resources available from the resource groups with the goals and objectives of the organizations and storing the matches in the repository; program instructions, stored on at least one of the one or more storage devices to, assign values and weights to the resources and optimize the resources; program instructions, stored on at least one of the one or more storage devices to, determine global optima and parse the global optima into resource allocation subsets for each resource group and send the resource allocation subsets to the resource groups; program instructions, stored on at least one of the one or more storage devices to, capture locally chosen resource allocation from the resource groups and store the locally chosen resource allocation in the repository; program instructions, stored on at least one of the one or more storage devices to, determine unstated weights and values from the locally chosen resource allocation from the resource groups; program instructions, stored on at least one of the one or more storage devices to, store actual pairings of the resources with a project of the organization; and program instructions, stored on at least one of the one or more storage devices to recalculate the global optima based on remaining resources available from the resource groups and store the recalculated global optima in the repository.

According to another embodiment of the present invention, a computer system for optimizing resources for organizations. The computer system comprising: one or more processors, one or more computer-readable memories and one or more computer-readable, tangible storage devices; program instructions, stored on at least one of the one or more storage devices for execution by at least one of the one or more processors via at least one of the one or more memories, to discover goals and objectives of organizations and the resources available from resource groups and storing data regarding the goals and objectives and the resources in a repository; program instructions, stored on at least one of the one or more storage devices for execution by at least one of the one or more processors via at least one of the one or more memories, to categorize the data regarding the goals and objectives and the resources available and storing the categorized data in the repository; program instructions, stored on at least one of the one or more storage devices for execution by at least one of the one or more processors via at least one of the one or more memories, to match the resources available from the resource groups with the goals and objectives of the organizations and storing the matches in the repository; program instructions, stored on at least one of the one or more storage devices for execution by at least one of the one or more processors via at least one of the one or more memories, to assign values and weights to the resources and optimize the resources; program instructions, stored on at least one of the one or more storage devices for execution by at least one of the one or more processors via at least one of the one or more memories, to determine global optima and parse the global optima into resource allocation subsets for each resource group and send the resource allocation subsets to the resource groups; program instructions, stored on at least one of the one or more storage devices for execution by at least one of the one or more processors via at least one of the one or more memories, to capture locally chosen resource allocation from the resource groups and store the locally chosen resource allocation in the repository; program instructions, stored on at least one of the one or more storage devices for execution by at least one of the one or more processors via at least one of the one or more memories, to determine unstated weights and values from the locally chosen resource allocation from the resource groups; program instructions, stored on at least one of the one or more storage devices for execution by at least one of the one or more processors via at least one of the one or more memories, to store actual pairings of the resources with a project of the organization; and program instructions, stored on at least one of the one or more storage devices for execution by at least one of the one or more processors via at least one of the one or more memories, to recalculate the global optima based on remaining resources available from the resource groups and store the recalculated global optima in the repository.

### BRIEF DESCRIPTION OF THE SEVERAL VIEWS OF THE DRAWINGS

FIG. 1 shows depicts a pictorial representation of a network of computers in which illustrative embodiments may be implemented.

FIGS. 2-3 show a method of optimizing resources to meet organization goals and objectives.

FIG. 4 shows a high level view of various claimants to the resource optimization process and their interactions.

FIG. 5 shows illustrates internal and external components of a client computer and a server computer in which illustrative embodiments may be implemented.

### DETAILED DESCRIPTION

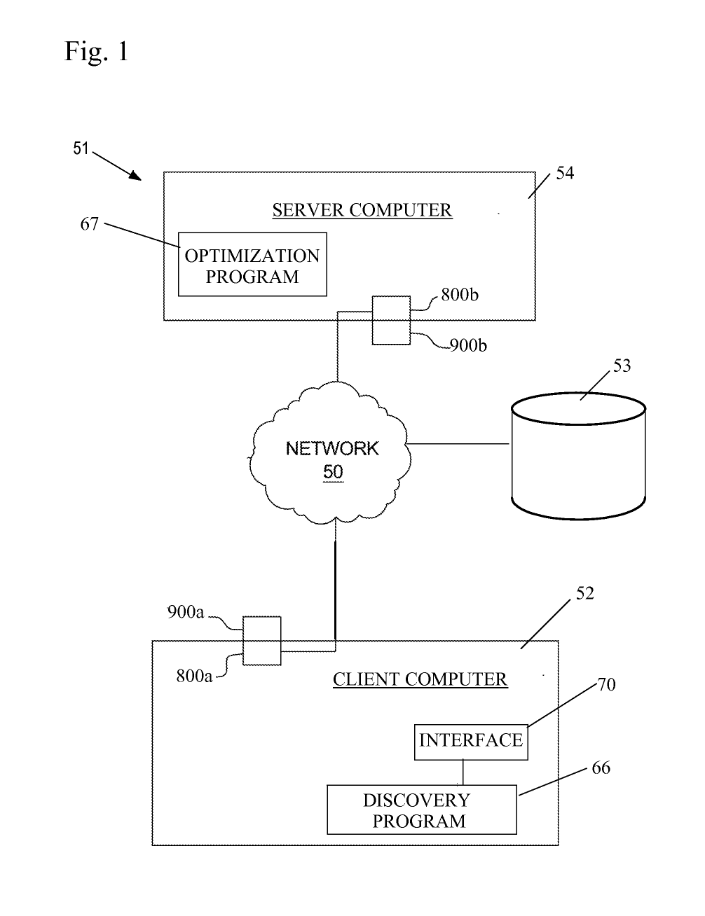

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

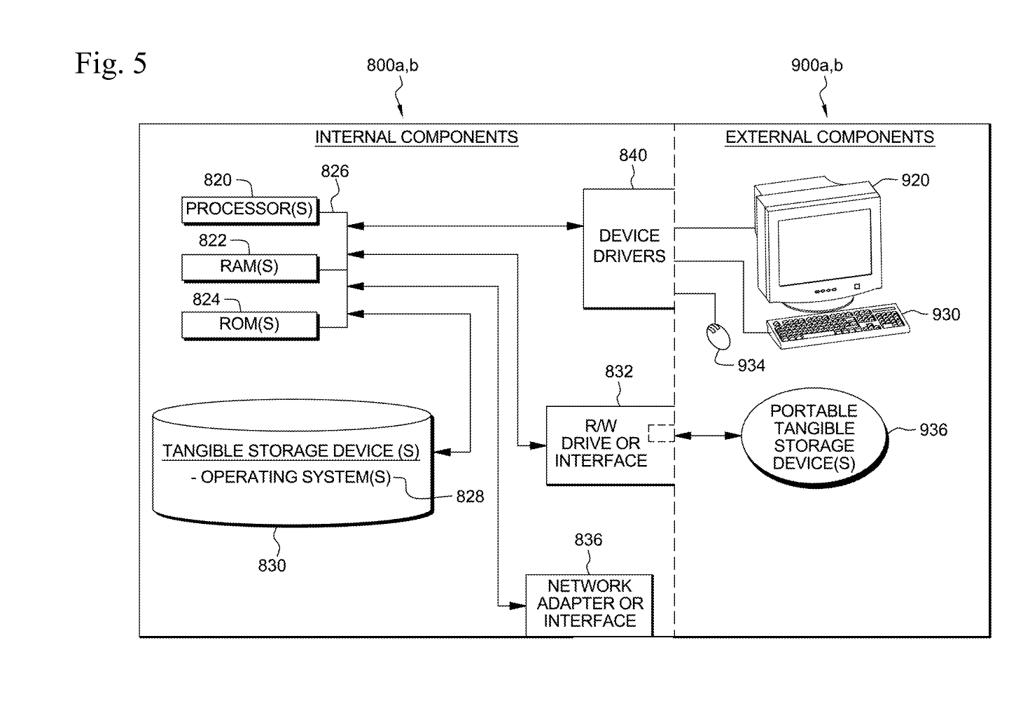

In the depicted example, client computer 52, tangible storage device 53, and server computer 54 connect to network 50. In other exemplary embodiments, network data processing system 51 may include additional client computers, storage devices, server computers, and other devices not shown. Client computer 52 includes a set of internal components 800a and a set of external components 900a, further illustrated in FIG. 5. Client computer 52 may be, for example, a mobile device, a cell phone, a personal digital assistant, a netbook, a laptop computer, a tablet computer, a desktop computer, or any other type of computing device. Client computer 52 may contain an interface 70. The interface 70 may accept commands and data entry from a user as well as display data. The interface 70 can be, for example, a command line interface, a graphical user interface (GUI), or a web user interface (WUI) through which a user can access a network including a discovery program 66 or an optimization program 67 on either client computer 52 or server computer 54. Server computer 54 includes a set of internal components 800b and a set of external components 900b illustrated in FIG. 5.

In the depicted example, server computer 54 provides information, such as boot files, operating system images, and applications to a client computer 52. Server computer 54 can compute the information locally or extract the information from other computers on network 50.

Program code and programs such as a discovery program 66 and an optimization program 67 may also be located in network data processing system 51 and may be stored on at least one of one or more computer-readable tangible storage devices 830 shown in FIG. 5, on at least one of one or more portable computer-readable tangible storage devices 936 as shown in FIG. 5, on tangible storage device 53 connected to network 50, or downloaded to a data processing system or other device for use. For example, program code and programs such as a discovery program 66 or an optimization program 67 may be stored on at least one of one or more tangible storage devices 830 on server computer 54 and downloaded to client computer 52 over network 50 for use on client computer 52. Alternatively, server computer 54 can be a web server, and the program code, and programs such as a discovery program 66 or an optimization program 67 may be stored on at least one of the one or more tangible storage devices 830 on server computer 54 and accessed on client computer 52. In other exemplary embodiments, the program code, and programs such as a discovery program 66 or an optimization program 67 may be stored on at least one of one or more computer-readable tangible storage devices 830 on client computer 52 or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

In one embodiment of the present invention, the limited social investments or resources to support betterment attempts by organizations is managed and optimized. The organizations may be private or public and have a presence at a local level, county level, state level, national level, or international level. The present invention aids the organizations in finding resources at all levels to help complete projects that will better the community. The present invention adds weight and value to what actions have been taken by the funding sources or resource groups and the organizations in the past, optimizing the matching of resources to organizational projects. The present invention also adds weight and value to how successful the pairing of resources with organization projects was and whether there were external causes that may have affecting the outcome. The outcome of the pairing of the resources with the organizational projects provides additional information for adjusting the weights and values that optimize the resources and pair the resources or funding sources with organizational projects.

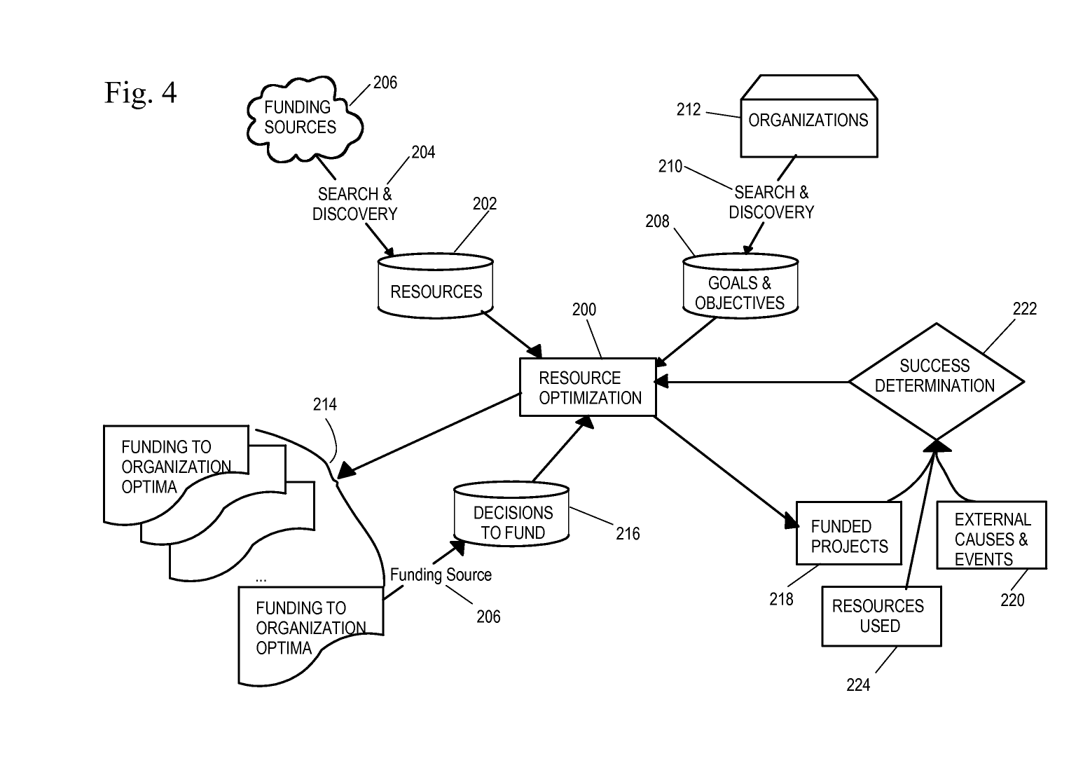

FIG. 4 shows a high level view of various claimants to the resource optimization process and their interactions.

Through a process of search and discovery 210, as noted below, the goals and objectives of organizations 212 with projects that need funding and resources are found and stored in a repository 208. The goals and objectives 208 are based on documentation regarding the organization itself including political views of the organization and the actual actions of the organization. Similarly, through a process of search and discovery 204, funding sources or resource groups and their associated resources are stored in a repository 202.

For examples of the a process of search and discovery process 204, 210, the goals and objectives of the organizations 212 and the resources of the funding sources 206 may be manually entered through an interface or by one or more automated entry methods, such as from the web or Internet, from e-mails, or by text mining. The data can then be entered into one or more databases 202, 208. Further details can be found below.

The databases 202, 208 provide input for resource optimization 200. The term “the resource optimization” is understood to mean a method of optimization of resources implemented through a computer. Resource optimization 200 categorizes the resources and goals and objectives, provides a ranked list that brings that categorized goals and objectives of an organization together with categorized resources, and assigns values and weights to the resources.

The resource optimization 200 outputs global optima and parses the global optima into resource allocation subsets for review by the funding sources 206, shown as funding to organization optima 214. The funding sources 206 consider the resource allocation subsets and choose how the resources are to be actually allocated. These choices, and possibly some indications of the decision-making process which arrived at the choices, are stored in a repository 216. Repository 216 forms an input to the resource optimization 200, which can then adjust the global optima based on the now remaining resources and adjust the weights and values assigned to resources and projects based on the resource group choices. The resource optimization 200 also provides information on what projects 218 were actually funded by the funding sources 206.

A success determination 222 is made at a later time by examining information regarding the funded projects 218, external causes and events 220 that may have influenced the outcome of the pairing of resources with projects, and resources 224 which were actually used by the project. The success determination 222 is provided as an input to the resource optimization 200, which can then take the determination into account by adjusting the weights and values of resources and organization projects as appropriate.

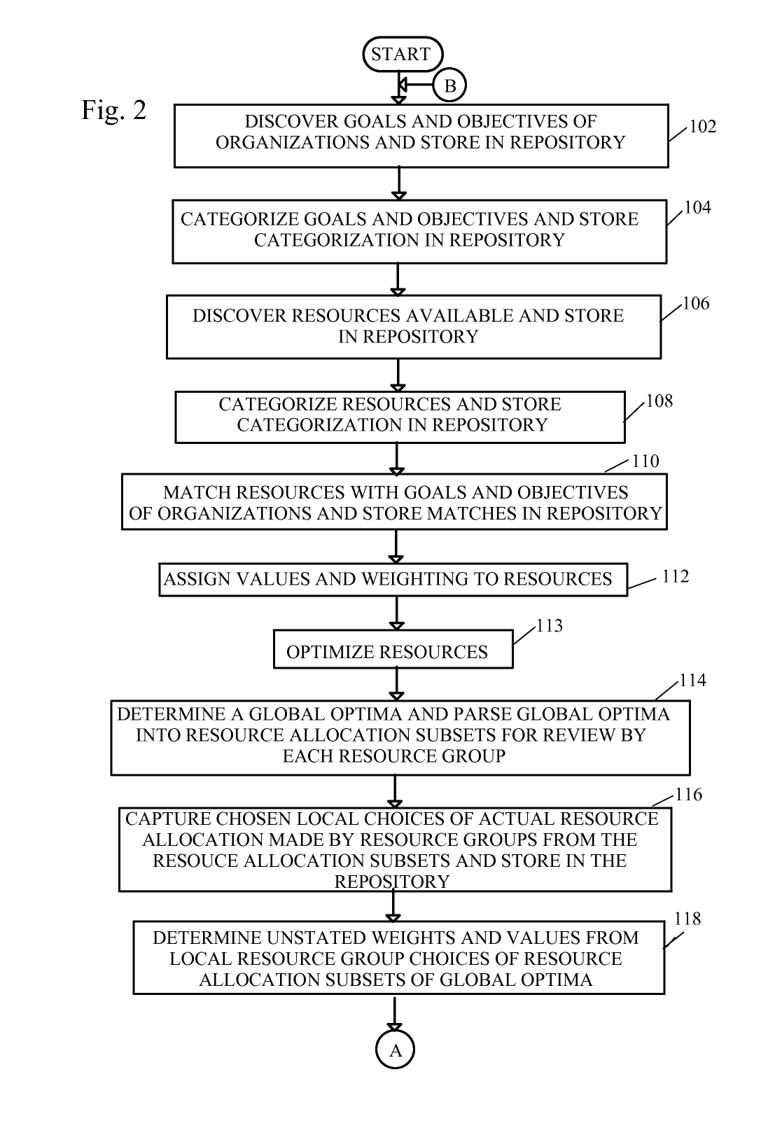

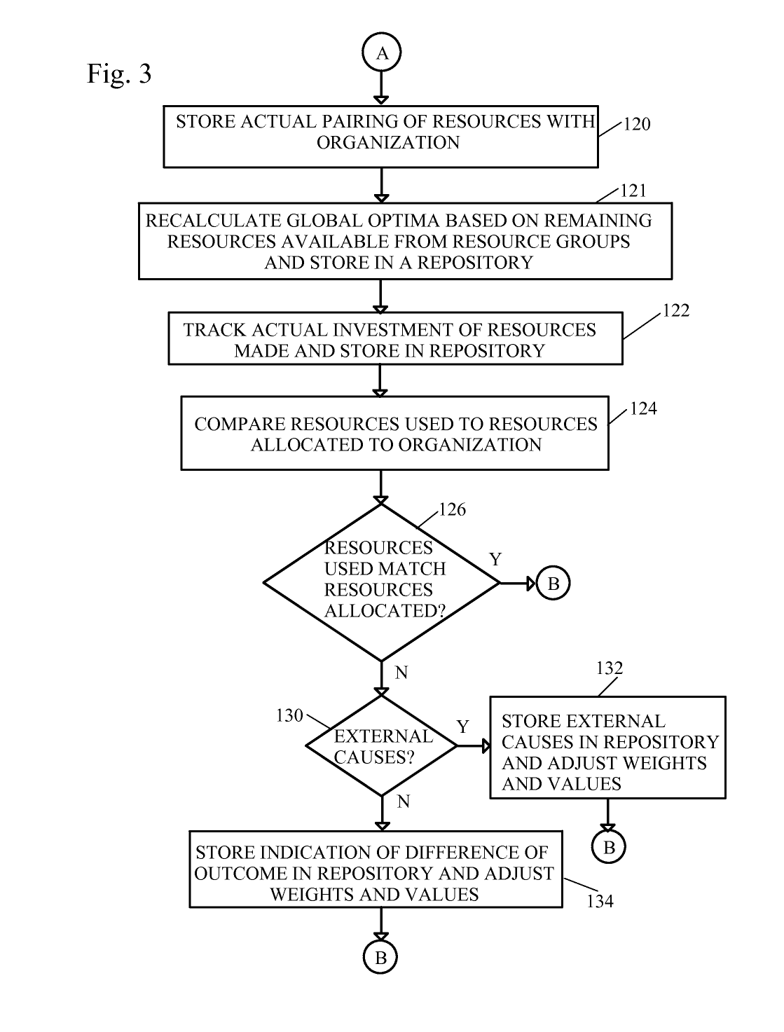

FIGS. 2-3 show a method of optimizing resources to meet organization goals and objectives. Through a computer program such as discovery program 66, the goals and objectives or objective statements of organizations are discovered and stored in a repository (step 102). The discovery program uses discovery techniques to discover the goals and objective of the organizations at multiple levels, for example private, local, county, state, national and international organizations. This is preferably done automatically using methods of computer-implemented search and discovery. The discovery includes, but is not limited to the techniques of applying text analytics to documents as well as data mining and text mining of various documents relating to the organization itself. The documents may be private, first party documents provided by the organization itself, third party documents describing the organization, including actual actions the organization has taken, or other documents present on the Internet or in other databases.

The goals and objects or projects discovered are categorized and the categorization is stored in a repository (step 104). The categories may be established by the organization themselves and customized as appropriate. The categorization may be hierarchical or otherwise related.

The resources available are also discovered and stored in a repository (step 106). The resources include, but are not limited to, monetary funding; physical resources such as building materials; labor; skills of individuals or groups; licenses of individuals or groups; real property assets such as ownership or leases of land or buildings; transportation means; and intellectual property. The resources may be individual resources or the resources may be set together as a package. The discovery of the resources may be carried out by a discovery program 66, as in step 102. The discovery program 66 uses discovery techniques to discover resources of funding sources or resource groups at multiple levels, for example private, local, county, state, national and international funding organizations. The discovery includes, but is not limited to the techniques of applying text analytics to various documents, and data mining and text mining of various documents relating to the organization itself. The documents may be private, first party documents provided by the resource organization itself, third party documents describing the resources of organization, including actual actions the resource organization has taken, or other documents present on the Internet or in other databases.

The discovered available resources are categorized and the categorization is stored in a repository (step 108). The categories may be set by the organizations and/or the resource groups or funding sources, and, as above, may be hierarchical or otherwise related.

The categorized, discovered resources are then matched with the categorized goals and objectives or projects of the organizations and information regarding the matches is stored in a repository (step 110).

It should be noted that steps 102 and 104 may run in parallel to steps 106 and 108. Furthermore, steps 106 and 108 of discover and categorizing resources may take place prior to steps 102 and 104 of discovering and categorizing goals and objectives.

Values and weights are then assigned to the resources (step 112), and these values and weights are used in the process of resource optimization (step 113). The resource optimization may be carried out by an optimization program 67. It should be noted that the actual actions of the resource group and the other organizations are should be given more weight and value than statements regarding the goals or objectives of the organization.

The methods described herein maximize the total value of the pairing of resource allocation or budget of a resource group with a project (goals and objectives) of an organization. The objective function that is maximized is:

$$Maximize {\sum }_{j = 1}^{n} {\sum }_{k = 1}^{m} {X}_{j , k} {W}_{j} {G}_{j}$$

subject to the following conditions:

$${{\sum }_{j = 1}}^{n} {X}_{j , k} {G}_{j} \leq {B}_{k} ( for k = 1 … m )$$

$$( \begin{matrix}total spending by each resource group must be less than \\ or equal to the budget or resource allocation avaiable\end{matrix} )$$

$${X}_{j , k} ∈ 0 , 1 \\ ( all with all projects of an organization are funded or not funded )$$

$${\sum }_{k = 1} {X}_{j , k} \leq 1 ( for j = 1 … n )$$

$$( all projects being only funded once )$$

$${\sum }_{j = 1}^{n} {X}_{j , k} \leq 1 ( for k = 1 … m )$$

$$( resource groups only funding a projects of an organization once )$$

where:

n=number of projects (goals and objectives)

m=number of resource groups

X_{j,k} ∈ 0, 1 is the j^{th} organization project (goals and objectives) funded by the k^{th} resource group

Bₖ=the total funding budget of the k^{th} resource group

Wⱼ=the social value weight of funding the j^{th} organization project (goals and objectives)

Gⱼ=organization project j^{th} dollar amount.

Global optima is determined and the global optima is parsed into resource allocation subsets for review by each resource group or funding source (step 114).

Each resource group reviews the resource allocation subsets and chooses how the resource allocation is actually to occur. The local resource allocation choices made by the resource group are captured and stored in a repository (step 116). The capture of the local optima chosen may include capture of information about the actual internal discussions and decision-making process of the resource group to determine resource allocation chosen or which organizations would be funded by the resource organization. Meaning may be derived from the discussions and is stored and used to adjust the values and weights applied for resource optimization.

For example, the global optima, could have: 50% of resource allocation of a resource group going to a homeless shelter in the area, 20% of the resource allocation allotted to soup kitchens in the area, and the remaining 30% resource allocation allotted to the Salvation Army, with the resource allocation subset including specifics regarding which resources are to actually go the organizations. The resource group could choose to distribute the resource allocation in another variation, for example, 70% of resource allocation to the soup kitchens in the area and the remaining 30% of the resource allocation to the homeless shelter, with no allocation for the Salvation Army.

Unstated weights and values are determined from the local resource group choices in regards to the resource allocation subsets (step 118). The unstated weights and values may be determined by an optimization program 67 shown in FIG. 1. In other words, if a resource group would fund an organization which has not been funded previously, the goals and the objectives of the newly chosen organization are given more weight, since the resource organization took action to begin funding that particular organization.

The actual pairing of resources with the organizations is stored in a repository (step 120). In other words, the repository stores information regarding what resources and funding are actually provided to which organization(s).

The global optima is recalculated based on the remaining resources available from each resource group and stored in a repository (step 121). By recalculated the global optima as resources are used, the resources available for the resource groups to attribute to organizations remains current.

Throughout the term of a project or agreement between an organization and the resource group or funding source, information regarding the actual investment of resources provided by the resource group to the organization is tracked and stored in a repository (step 122).

After the project is completed, information regarding the resources that were actually used in the project is compared to the resources allocated (step 124). For example, one hundred blankets are promised to a homeless shelter by a funding source for the winter. When the winter is over, the blankets actually delivered to the organization are counted and compared to the promised number of blankets the resource group committed to providing.

If the resources used matched the resources allocated (step 126), return to step 102.

If the resources used did not match the resources allocated (step 126), such that resources were over- or under-allocated, check to see if there were external causes which might explain the difference (step 130). If there were, store information about any external causes which were found in the repository and, if it is determined that the external cause is of a nature which would affect future actions, adjust the weights and values of the resource for resource optimization (step 132). Return to step 102.

For example, continuing with the homeless shelter example, suppose seventy blankets were delivered instead of the promised one hundred blankets. On investigation, it is found that the winter was unseasonably warm and therefore less people came to the shelter and requested blankets. In that case, the unseasonably warm winter would be an external cause, and information about the weather would be stored in the repository. The weights and values of the resource (in this case the blankets) probably would not need to be adjusted, since future winters are more likely to be seasonable than unseasonable (by definition).

Using the same example, suppose that the investigation of external causes found that another shelter had opened a block away, and it was also providing blankets. In this case, the weights and values of the resource “blanket” would be adjusted to reflect the increased supply in general and the likely reduced demand for blankets from this shelter in the future.

If no external causes for a difference could be determined (step 130), that would likely indicate an error or other unexplained inaccuracy in projection. In such a case, store an indication of the difference in the outcome in the repository, and adjust the weights and values of the resources to reflect the difference. Return to step 102.

Preferably, in the method of the invention, as much relevant data will be entered as feasible. The entry may be done by manual entry or by one or more automated entry methods, such as from the web, from e-mails, or by text mining The data can then be entered into one or more databases. Querying the database for matches of announcements, resources, and assets can allow optimization of available resources to projects. This may involve multiple query algorithms and optimization algorithms which may be found in a discover program 66 or an optimization program 67 for example.

The atomic data from all of the inputs may be entered into a suitable data mining data warehouse, utilizing organization methods such as a constellation schema or star schema or similar queryable schema or structure, with conformal dimensions. Working from such schema in a data warehouse, various optimization algorithms are enabled to match goals and objectives of organizations to resources. This facilitates self learning.

By way of exemplification and not limitation, the optimization functions are typically of the type “maximize or minimize a sum of functions of the inputs subject to a set of constraints to derive an optimized objective function.”

The data retrieved and processed may be one or both of discrete or semantic, with both the totality of the data and the individual items of data being one or both of discrete or semantic. This type of data may be effectively managed by an Unstructured Information Management Architecture (UIMA).

UIMA is an open, industrial-strength, scaleable and extensible platform for creating, integrating and deploying unstructured information management solutions from combinations of semantic analysis and search components. IBM's UIMA is a component-based software architecture for developing unstructured information management (UIM) applications.

A UIM application may be generally characterized as a software system that analyzes large volumes of unstructured information (both discrete and semantic) in order to discover, organize, and deliver relevant knowledge to the end user. An example is an application that processes millions of projects to discover critical resources for the betterment of a population facing hunger or disease. Another example is an application that processes tens of millions of documents to discover evidence of probable terrorist activities.

UIMA is an open framework for building analytic applications to find latent meaning, relationships and relevant facts hidden in unstructured text. UIMA defines a common, standard interface that enables text analytics components from multiple vendors to work together. It provides tools for either creating new interoperable text analytics modules or enabling existing text analytics investments to operate within the framework.

In analyzing unstructured content, UIM applications make use of a variety of technologies including statistical and rule-based natural language processing (NLP), information retrieval, machine learning, ontologies, and automated reasoning. UIM applications may consult structured sources to help resolve the semantics of the unstructured content. For example, a database of resources available, such as volunteers with cars, can help in focusing whether meals to hundreds of people can be delivered to qualified recipients for the holidays.

A UIM application generally produces structured information resources that unambiguously represent content derived from unstructured information input. These structured resources are made accessible to the end user through a set of application-appropriate access methods. A simple example is a search index and query processor that makes documents quickly accessible by topic and ranks them according to their relevance to key concepts specified by the user. A more complex example is a formal ontology and inference system that, for example, allows the user to explore the concepts, their relationships, and the logical implications contained in a collection consisting of millions of documents.

A further tool is Semantic Search. Semantic Search is a class of document retrieval that allows the user to exploit the results of UIMA analysis to create much more effective queries—queries that can hone in on exactly what you are looking for.

IBM's WebSphere Information Integrator system provides a UIMA compliant processing engine and rich platform for deploying text analytic solutions, which is an example of a system which can be used with the invention. A wide range of powerful text analytics can be used together to extract concepts, facts, and relationships from text helping organizations get more insight and value from enterprise content assets. This facilitates taking discrete and semantic data as inputs and provides an output that may be further processed in an optimization tool, as an integer optimization tool, or, preferably an optimization tools that can optimize semantic and discrete data with respect to objective functions that contain discrete and semantic objectives.

Text analytics can analyze documents, comment and note fields, problem reports, e-mail, web sites and other text-based information sources. Extracted information can be used to enhance the quality of search results, or analyzed alongside traditional data as part of business intelligence and data warehousing applications to provide a more complete view of operations, opportunities and risks.

UIMA architectures, applications, and platforms may be used with an optimization application that can process and optimize both discrete and semantic data (such as the data retrieved and presented by UIMA)

IBM's WebSphere® system may also be used for web crawling and for the semantic search of resources of resource groups and goals and objectives of organizations to obtain the semantic data, and can also be used to search databases 202, 208 as well as other databases such as the Internet, in a semantic search to determine resource group or organization interests for input to the resource optimization process 200.

A further aspect of the method, system, and program product is a feedback mechanism for the resource optimization. That is, where funding was suggested to be awarded, what funding or resources was actually awarded and what was the performance of the project. This may be followed by tracking other measures of success, such as actual benefit to the community in which the project was funded, which is an input through success determination 222, to the resource optimization process 200.

FIG. 5 illustrates internal and external components of client computer 52 and server computer 54 in which illustrative embodiments may be implemented. In FIG. 5, client computer 52 and server computer 54 include respective sets of internal components 800a, 800b, and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and a discovery program 66 and an optimization program 67 are stored on one or more of the computer-readable tangible storage devices 830 for execution by one or more of the processors 820 via one or more of the RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. A discovery program 66 and an optimization program 67 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. A discovery program 66 and an optimization program 67 can be downloaded to computer 52 and server computer 54 from an external computer via a network (for example, the Internet, a local area network or other, wide area network) and network adapter or interface 836. From the network adapter or interface 836, a search results program 66 is loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 940. Each of the sets of internal components 800a, 800b also includes device drivers 840 to interface to computer display monitor 920, keyboard 930 and computer mouse 940. The device drivers 840, R/W drive or interface 832 and network adapter or interface 836 comprise hardware and software (stored in storage device 830 and/or ROM 824).

A discovery program 66 and an optimization program 67 can be written in various programming languages including low-level, high-level, object-oriented or non object-oriented languages. Alternatively, the functions of a discovery program 66 and an optimization program 67 can be implemented in whole or in part by computer circuits and other hardware (not shown).

Based on the foregoing, a computer system, method and program product have been disclosed for optimizing resources for organizations. However, numerous modifications and substitutions can be made without deviating from the scope of the present invention. Therefore, the present invention has been disclosed by way of example and not limitation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for optimizing resources for organizations, the method comprising the steps of:
a computer discovering goals and objectives of organizations and the resources available from resource groups and storing data regarding the goals and objectives and the resources in a repository;
the computer categorizing the data regarding the goals and objectives and the resources available and storing the categorized data in the repository;
the computer matching the resources available from the resource groups with the goals and objectives of the organizations and storing the matches in the repository;
the computer assigning values and weights to the resources and optimizing the resources;
the computer determining global optima and parsing the global optima into resource allocation subsets for each resource group and sending the resource allocation subsets to the resource groups;
the computer capturing locally chosen resource allocation from the resource groups and storing the locally chosen resource allocation in the repository;
the computer determining unstated weights and values from the locally chosen resource allocation from the resource groups;
the computer storing actual pairings of the resources with a project of the organization; and
the computer recalculating the global optima based on remaining resources available from the resource groups and storing the recalculated global optima in the repository.

2. The method of claim 1, wherein during the project, the method further comprises the step of the computer tracking actual investment of resources made by the resource group to the organization and storing data regarding the actual investment in the repository.

3. The method of claim 1, wherein after completion of the project, the method further comprising the steps of:
comparing the resources used by the project of the organization to the resources allocated to the organization by the resource group;
if the resources used do not match the resources allocated to the project of the organization by the resource group, and external causes are discovered, the computer storing the external causes in the repository and determining whether the values and weights of the resources are to be adjusted and return to the step of the computer discovering the goals and objectives of the organizations and the resources available from the resource groups and storing data regarding the goals and objectives and the resources in the repository; and
if the resources used do not match the resources allocated to the project of the organization by the resource group, and external causes are not discovered, the computer storing an indication of a difference in the repository and return to the step of the computer discovering the goals and objectives of the organizations and the resources available from the resource groups and storing data regarding the goals and objectives and the resources in the repository.

4. The method of claim 3, further comprising the step of if the resources used match the resources allocated to the project of the organization by the resource group, returning to the step of the computer discovering the goals and objectives of the organizations and the resources available from the resource groups and storing data regarding the goals and objectives and the resources in the repository.

5. The method of claim 1, wherein the resources consist of monetary funding; physical resources such as building materials; real property; labor; skills of individuals or groups; licenses of individuals or groups; transportation means; and intellectual property.

6. The method of claim 1, wherein the goals and objectives of the organization includes political views of the organization.

7. A computer program product comprising one or more computer-readable, tangible storage devices and computer-readable program instructions which are stored on the one or more storage devices and when executed by one or more processors, perform all of the step of claim 1.

8. A computer system comprising one or more processors, one or more computer-readable memories, one or more computer-readable, tangible storage devices and program instructions which are stored on the one or more storage devices for execution by the one or more processors via the one or more memories and when executed by the one or more processors implement all the steps of claim 1.

9. A computer program product for optimizing resources for organizations, the computer program product comprising:
one or more computer-readable, tangible storage devices;
program instructions, stored on at least one of the one or more storage devices to, discover goals and objectives of organizations and the resources available from resource groups and storing data regarding the goals and objectives and the resources in a repository;
program instructions, stored on at least one of the one or more storage devices to, categorize the data regarding the goals and objectives and the resources available and storing the categorized data in the repository;
program instructions, stored on at least one of the one or more storage devices to, match the resources available from the resource groups with the goals and objectives of the organizations and storing the matches in the repository;
program instructions, stored on at least one of the one or more storage devices to, assign values and weights to the resources and optimize the resources;
program instructions, stored on at least one of the one or more storage devices to, determine global optima and parse the global optima into resource allocation subsets for each resource group and send the resource allocation subsets to the resource groups;
program instructions, stored on at least one of the one or more storage devices to, capture locally chosen resource allocation from the resource groups and store the locally chosen resource allocation in the repository;
program instructions, stored on at least one of the one or more storage devices to, determine unstated weights and values from the locally chosen resource allocation from the resource groups;
program instructions, stored on at least one of the one or more storage devices to, store actual pairings of the resources with a project of the organization; and
program instructions, stored on at least one of the one or more storage devices to recalculate the global optima based on remaining resources available from the resource groups and store the recalculated global optima in the repository.

10. The computer program product of claim 9, wherein during the project, further comprising program instructions, stored on at least one of the one or more storage devices to, track actual investment of resources made by the resource group to the organization and store data regarding the actual investment in the repository.

11. The computer program product of claim 9, wherein after completion of the project, further comprising:
program instructions, stored on at least one of the one or more storage devices to, compare the resources used by the project of the organization to the resources allocated to the organization by the resource group;
if the resources used do not match the resources allocated to the project of the organization by the resource group, and external causes are discovered, program instructions, stored on at least one of the one or more storage devices to, store the external causes in the repository and determine whether the values and weights of the resources are to be adjusted and return to the program instructions, stored on at least one of the one or more storage devices to, discover the goals and objectives of organizations and the resources available from the resource groups and store data regarding the goals and objectives and the resources in the repository; and
if the resources used do not match the resources allocated to the project of the organization by the resource group, and external causes are not discovered, program instructions, stored on at least one of the one or more storage devices to, store an indication of a difference in the repository and return to program instructions, stored on at least one of the one or more storage devices to, discover the goals and objectives of organizations and the resources available from the resource groups and storing data regarding the goals and objectives and the resources in the repository.

12. The computer program product of claim 11, further comprising if the resources used match the resources allocated to the project of the organization by the resource group, returning to program instructions, stored on at least one of the one or more storage devices to, discover the goals and objectives of the organizations and the resources available from the resource groups and storing data regarding the goals and objectives and the resources in the repository.

13. The computer program product of claim 9, wherein the resources consist of monetary funding; physical resources; real property; labor; skills of individuals or groups; licenses of individuals or groups; transportation means; and intellectual property.

14. The computer program product of claim 9, wherein the goals and objectives of the organization includes political views of the organization.

15. A computer system for optimizing resources for organizations, the computer system comprising:
one or more processors, one or more computer-readable memories and one or more computer-readable, tangible storage devices;
program instructions, stored on at least one of the one or more storage devices for execution by at least one of the one or more processors via at least one of the one or more memories, to discover goals and objectives of organizations and the resources available from resource groups and storing data regarding the goals and objectives and the resources in a repository;
program instructions, stored on at least one of the one or more storage devices for execution by at least one of the one or more processors via at least one of the one or more memories, to categorize the data regarding the goals and objectives and the resources available and storing the categorized data in the repository;
program instructions, stored on at least one of the one or more storage devices for execution by at least one of the one or more processors via at least one of the one or more memories, to match the resources available from the resource groups with the goals and objectives of the organizations and storing the matches in the repository;
program instructions, stored on at least one of the one or more storage devices for execution by at least one of the one or more processors via at least one of the one or more memories, to assign values and weights to the resources and optimize the resources;
program instructions, stored on at least one of the one or more storage devices for execution by at least one of the one or more processors via at least one of the one or more memories, to determine global optima and parse the global optima into resource allocation subsets for each resource group and send the resource allocation subsets to the resource groups;
program instructions, stored on at least one of the one or more storage devices for execution by at least one of the one or more processors via at least one of the one or more memories, to capture locally chosen resource allocation from the resource groups and store the locally chosen resource allocation in the repository;
program instructions, stored on at least one of the one or more storage devices for execution by at least one of the one or more processors via at least one of the one or more memories, to determine unstated weights and values from the locally chosen resource allocation from the resource groups;
program instructions, stored on at least one of the one or more storage devices for execution by at least one of the one or more processors via at least one of the one or more memories, to store actual pairings of the resources with a project of the organization; and
program instructions, stored on at least one of the one or more storage devices for execution by at least one of the one or more processors via at least one of the one or more memories, to recalculate the global optima based on remaining resources available from the resource groups and store the recalculated global optima in the repository.

16. The system of claim 15, wherein during the project, further comprising program instructions, stored on at least one of the one or more storage devices for execution by at least one of the one or more processors via at least one of the one or more memories, to track actual investment of resources made by the resource group to the organization and store data regarding the actual investment in the repository.

17. The system of claim 15, wherein after completion of the project, further comprising:
program instructions, stored on at least one of the one or more storage devices for execution by at least one of the one or more processors via at least one of the one or more memories, to compare the resources used by the project of the organization to the resources allocated to the organization by the resource group;
if the resources used do not match the resources allocated to the project of the organization by the resource group, and external causes are discovered, program instructions, stored on at least one of the one or more storage devices for execution by at least one of the one or more processors via at least one of the one or more memories, to store the external causes in the repository and determine whether the values and weights of the resources are to be adjusted and return to the program instructions, stored on at least one of the one or more storage devices for execution by at least one of the one or more processors via at least one of the one or more memories, to discover the goals and objectives of organizations and the resources available from the resource groups and store data regarding the goals and objectives and the resources in the repository; and
if the resources used do not match the resources allocated to the project of the organization by the resource group, and external causes are not discovered, program instructions, stored on at least one of the one or more storage devices for execution by at least one of the one or more processors via at least one of the one or more memories, to store an indication of a difference in the repository and return to program instructions, stored on at least one of the one or more storage devices for execution by at least one of the one or more processors via at least one of the one or more memories, to discover the goals and objectives of organizations and the resources available from the resource groups and storing data regarding the goals and objectives and the resources in the repository.

18. The system of claim 17, further comprising if the resources used match the resources allocated to the project of the organization by the resource group, returning to program instructions, stored on at least one of the one or more storage devices for execution by at least one of the one or more processors via at least one of the one or more memories, to discover the goals and objectives of the organizations and the resources available from the resource groups and storing data regarding the goals and objectives and the resources in the repository.

19. The computer program product of claim 15, wherein the resources consist of monetary funding; physical resources; real property; labor; skills of individuals or groups; licenses of individuals or groups; transportation means; and intellectual property.

20. The computer program product of claim 15, wherein the goals and objectives of the organization includes political views of the organization.
